(19) United States
(12) Patent Application Publication
(10) Pub. No.: US 2026/0050430 A1
(43) Pub. Date: Feb. 19, 2026

(54) Forward Compatible Secure Streaming Recursive Software Image

(71) Applicant: Arista Networks, Inc., Santa Clara, CA (US)

(72) Inventors: Eudean Michael Sun, Walnut Creek, CA (US); Baptiste Elie Franck Covolato, Vancouver (CA); Peter Eduard Rufer, Palo Alto, CA (US)

(21) Appl. No.: 18/758,656

(22) Filed: Jun. 28, 2024

(51) Int. Cl. G06F 8/61

(52) U.S. Cl. CPC G06F 8/63

(57) ABSTRACT

A method for installation of software can include downloading a software image over a network at a target device. The target device includes first installer code and the software image comprises second installer code and software program files for a software program to be installed. The method further comprises installing the software program on the target device from the software image. Installing the software program on the target device comprises extracting, by the first installer code, the second installer code from the software image while the software image is downloading from the install source, executing the second installer code at the target device, and processing the software image using the second installer code.

### TECHNICAL FIELD

This disclosure relates generally to the installation of software on computer devices. More particularly, this disclosure relates to dynamically executing an installer from the software image being installed.

### BACKGROUND OF THE RELATED ART

Some software upgrades and downgrades on target devices are often accomplished using a software image that includes instructions and other data to make the software ready for execution on the target device. The installation process typically involves an installer copying files from the software image, storing the files at appropriate locations on the target device, and configuring the target device. An installation may also include other processes, such as generating new code from the software image and storing the new code files at appropriate locations on the target device. The software image is embodied, in some implementations, as a compressed collection of program files that contain the instructions, configuration data, and other data needed to install the software program.

Depending on implementation, the software image is deployed using an installation media, such as a DVD or USB drive, or remotely over a network. In large networks, installation using an installation media is a time consuming and error prone process.

Network-based deployment solutions provide centralized management of software installation and maintenance through a network. Software installation onto target devices on the network is achieved by downloading the appropriate software images from a remote server and installing the software from the images on the target devices.

While effective for deploying software to multiple machines, network-based deployment still presents challenges related to flexibility, management, and customization. Because software images are typically device architecture or configuration specific, a large-scale network may require a large library of images, with administrators configuring the many target devices to request and servers to deploy the correct images. As another issue, the target device-side installer tool in network-based deployment solutions is designed to install software from images having a known structure. The deployment of software images having a new structure may result in fatal errors unless a compatible installer tool was previously deployed in a prior, separate deployment.

It is thus desired to provide a mechanism for deploying and installing software images that allows updated installer code (e.g., forward compatible installer code) to be executed from the software image to install the software image.

It is also desired to provide a flexible structure for software images that can support software images for multiple architectures, configurations, or programs as part of the same software image.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagrammatic representation of an example computing environment for installation of software.

FIG. 2 is a diagrammatic representation of one embodiment of installing software using a software image.

FIG. 3 is a diagrammatic representation of another embodiment of installing software using a software image.

FIG. 4A is a flow chart that illustrates an example of a process for installing software from a software image.

FIG. 4B is a flow chart that illustrates an example of a process for executing a new installer.

FIG. 5 is a diagrammatic representation of one embodiment of a network device.

### DETAILED DESCRIPTION

Specific embodiments will now be described with reference to the accompanying figures (FIGS). The figures and the following description describe certain embodiments by way of illustration only. One skilled in the art will readily recognize from the following description that alternative embodiments of the structures and methods illustrated herein may be employed without departing from the principles described herein. It is noted that wherever practicable similar or like reference numbers may be used in the figures and may indicate similar or like functionality.

Embodiments disclosed pertain to dynamically updating software image installer code on a target system from the software image being installed. Further, embodiments disclosed herein pertain to providing a flexible software image structure that includes multiple installable software programs and respective installer code sets. The flexible software image can be used to provide, for example, forward compatible, secure streaming, recursive, multi-architecture software images.

To this end, a software image is provided in which a portion of the software image has a structure compatible with an existing installer deployed at a target device. This portion of the software image includes new installer code. The target device extracts and executes the new installer to process the software image. Because the software image is structured so that the old installer can locate and execute the new installer code, the remainder of the image can have a different structure that is not compatible with the old installer but is compatible with the new installer. Preferably, the software image portion compatible with the old installer is located near the start of the software image, such that the old installer can extract and execute the new installer code on-the-fly as the software image is being downloaded.

In some embodiments, the software image includes multiple software programs and respective installer code sets. The old installer code on the target device selects the new installer code to execute from the software image and the new installer processes the software image to install the appropriate software program. To provide an illustrative example, the software image may include CPU architecture specific versions of a software program, with each version having its own version of the new installer code. The existing installer on the target device selects and executes installer code that corresponds to the target device's CPU architecture and the architecture-specific installer processes the software image to install the version of the software program appropriate to the target device's CPU architecture.

The software image may include any number of installer code sets that can be recursively executed to process the software image. As an example, the software image may include versions of a software program that are CPU architecture and device configuration specific, installer code sets that are CPU architecture specific, and installer code sets that are device configuration specific. In one embodiment, the existing installer on the target device selects and executes the appropriate architecture-specific installer code from the software image, the architecture-specific installer selects and executes the configuration-specific installer code from the software image, and the configuration-specific installer installs the CPU architecture/device configuration-specific version of the software program on the target device.

The software image may also include installer configuration data for an existing installer or for the installers included in the software image, where the installer configuration data specifies, for example, criteria for selecting or discarding files from the software image. The installer configuration data may include file metadata, such as filenames, content lengths, or other metadata for files to be processed. In some embodiments, the installer configuration data includes rules for selecting files. The rules may incorporate file metadata, context information (e.g., architecture, device configuration, or other context information) or other types of information.

In some embodiments, each installer in the chain passes (e.g., streams) the entire software image to the next installer in the recursive chain, with the final installer in the chain determining which files to process or discard. Returning to the previous example of installing an architecture/configuration specific version of a software program, the existing installer on the target device passes the software image to the architecture specific installer that was executed from the software image, the architecture specific installer passes the software image to the configuration specific installer that was executed from the software image, and the configuration specific installer processes the software image to install the version of the software program appropriate to the target device's architecture/configuration.

In other embodiments, one or more of the installers prior to the final installer in the chain can filter out portions of the software image to pass a modified software image to the final installer in the chain. For example, the existing installer on the target device may filter out some portions of the software image to pass a modified software image to the architecture specific installer, the architecture specific installer may filter out portions of the modified software image to pass a further modified, penultimate, software image to the configuration specific installer, and the configuration specific installer may further process the penultimate software image to install the version of the software program appropriate to the target device's architecture/configuration.

Software installation technologies implement a security model of not executing any code from a software image prior to verifying the image's signature and not executing any code from an unsigned image. However, this requires that the entire software image be available for verification before any code can be executed from the software image. Embodiments of the present disclosure, on the other hand, support securely executing code from a software image without requiring that the entire software image be available for verification. To this end, each installer code set in the software image can have its own signature so that an existing installer can verify the signature of an installer code set before executing a new installer. Thus, embodiments support the secure execution of code from a software image, while still allowing the software image to be processed as a stream.

Embodiments described herein can be used for the installation of a wide variety of software. As one specific example, the same software image may include different versions of an operating system (OS). In an even more particular example, the software image may include different versions of an extensible operating system or OS extensions for the extensible OS. Other examples include, but are not limited to, productivity software and games.

Embodiments of the present disclosure can simplify network-based deployment of software by reducing or eliminating the need to manage separate images for different versions of a software program. The same software image may contain different versions of a program, where each version corresponds to a respective set of system requirements required or recommended to run the program. As such, the same software image can be used to update devices having heterogeneous architectures or configurations.

One aspect of the present disclosure includes downloading a multi-architecture software image to a target device, such as a network device, where the multi-architecture software image file comprises recursive installer code and software program components for multiple architectures. The multi-architecture software image is used to install the software program on the target device. In more particular embodiments, the multi-architecture software image is used to install an OS on the target device. Installing the software program on the target device from the multi-architecture software image file can include extracting the recursive installer code corresponding to the device architecture of the target device and executing the recursive installer code to install the software program components corresponding to the device architecture. According to one embodiment, the multi-architecture software image includes a signature for each set of recursive installer code included in the software image. The signature of recursive installer code is validated prior to executing the recursive installer code.

Another aspect of present disclosure includes receiving a request for a software image from a target device and, responsive to the request, streaming a multi-architecture software image to the target device, where the multi-architecture software image file comprises recursive installer code and software program components for multiple architectures, including the architecture of the target device. In more particular embodiments, the multi-architecture software image is a multi-architecture OS image that can be used to install an OS on multiple architectures. The multi-architecture software image is at least partially compatible with installer code installed on the target device and the recursive installer code corresponding to the architecture of the target device is extractable and executable on the target device to install the software program components corresponding to the device architecture. According to one embodiment, the multi-architecture software image includes a signature for each set of recursive installer code included in the software image. The signature of recursive installer code is validated prior to executing the recursive installer code.

Another aspect of the present disclosure includes first installer code executable to read a first portion of a software image streaming to a target device, identify second installer code for extraction from the software image, extract the second installer code from the software image, and execute the second installer code on the fly to process the software image. The first installer code may be executable to pass the software image to the second installer code. In one embodiment, the first installer code forks to create a child process and executes the second installer code in the child process. Further, in one embodiment, the first installer code passes the software image to the child process via a pipe.

Yet another aspect of the present disclosure comprises a software image that includes software program components and one or more recursive installer code sets. Each recursive code set is executable on a target device to perform at least one of i) processing the software image to extract and execute a further recursive installer code set from the software image; or ii) install at least a subset of the software program components.

One aspect of the present disclosure includes a method for installation of software. Embodiments also include related computer devices, such as network devices, configured to implement the method for installation of software. Embodiments further include computer-readable media comprising instructions translatable by a processor to implement the method for installation of software.

According to one embodiment, a method for installation of software includes a target device downloading a software image over a network from an install source, where the target device comprises first installer code and the software image comprises second installer code and software program files for a software program to be installed. The software image may also include installer code for additional installers. The software image, according to one embodiment, is an operating system (OS) image file comprising a multi-architecture OS image.

The method further includes installing the software program on the target device from the software image. Installing the software program on the target device may further include the first installer code extracting the second installer code from the software image while the software image is downloading from the install source and executing the second installer code. Installing the software program on the target device may further include processing the software image using the second installer code. In some embodiments, the second installer code is extracted and executed prior to the target device receiving the entire software image.

According to one embodiment, the method for installation of software further includes buffering first streaming data in a buffer of the target device as buffered data, the first streaming data representing a first portion of the software image. The method may further include the first installer code passing the buffered data and a second portion of the software image to the second installer code.

According to one embodiment, the method for installation of software further includes validating a signature of the second installer code prior to executing the second installer code on the target device. In some embodiments, the signature of the second installer code is included in the software image.

The method for software installation may include one or more installers selectively processing or discarding software program files. For example, in one embodiment, the second installer code is executable to install a first of the software program files and discard a second of the software program files.

According to one embodiment, the software image is a compressed file that includes a first portion compatible with the first installer code and a second portion compatible with the second installer code, where the first portion includes the second installer code. The second portion may include the first of the software program files. The software image may also include a third portion that includes the second of the software program files.

The software image may include metadata for installer code, which may be used, in some embodiments, to select which installer code to extract and execute. For example, the method for installation of software may further include the first installer code selecting the second installer code for extraction and execution, where the first installer code selects the second installer code using the metadata for the second installer code. As another example, the second installer code may select third installer code for extraction and execution, where the second installer code selects the third installer code for extraction and execution using the metadata of the third installer code. Installing the software program may further include the second installer code extracting the third installer code from the software image and executing the third installer code. The software image may be processed using the third installer code.

Another aspect of the present disclosure includes a target device, such as a network device, that comprises a processor, a nonvolatile memory and instructions stored on the nonvolatile memory, where the instructions are translatable by the processor. Yet another aspect of the present disclosure includes a computer program product comprising a non-transitory, computer-readable medium storing instructions translatable by a processor. Embodiments also include related methods for installation of software.

The instructions are translatable by the processor for downloading a software image over a network from an install source. In accordance with one embodiment, the software image is an operating system OS image file comprising a multi-architecture OS image. The software image, in some implementations, is only partially compatible with the instructions.

The instructions are further translatable by the processor for identifying new installer code for execution from the software image, extracting the new installer code from the software image, executing the new installer code to instantiate a new installer, and streaming software image data to the new installer for processing. In some embodiments, the instructions are translatable to identify the new installer code while the software image is downloading.

According to one embodiment, the instructions are further translatable by the processor for buffering first streaming data in a buffer as buffered data, where the first streaming data represents a first portion of the software image. The instructions may be further translatable to pass the buffered data and a second portion of the software image to the new installer.

The instructions may be further translatable by the processor for validating a signature of the new installer code prior to executing the new installer code. The signature for the new installer code is included in the software in some embodiments.

The instructions may be further translatable by the processor for reading metadata for the new installer code from the software image and using the metadata for the new installer code in selecting the new installer code for extraction and execution.

In some embodiments, the new installer code is associated with a processor architecture of the target device. The instructions may be further translatable by the processor for ignoring or discarding installer code associated with a different processor architecture.

Embodiments of the present disclosure can simplify network-based deployment of software by reducing or eliminating the need to manage separate images for different versions of a software program.

Embodiments of the present disclosure provide an advantage over prior software deployment technologies by providing a forward compatible software image that can include updated installer code for installing the software image in the software image itself.

Embodiments of the present disclosure provide an advantage by providing a software image that can be used to install software on devices having different architectures or configurations.

As used herein, with respect to processing a software image, the terms “existing installer” and “old installer” refer to an installer that processes at least a portion of the software image, but is not extracted or executed from that software image. A “new installer” refers to an installer that is included in the software image for processing at least a portion of the software image. A “new installer” may, in some cases, be a rollback to a prior installer version compared to the “old installer.”

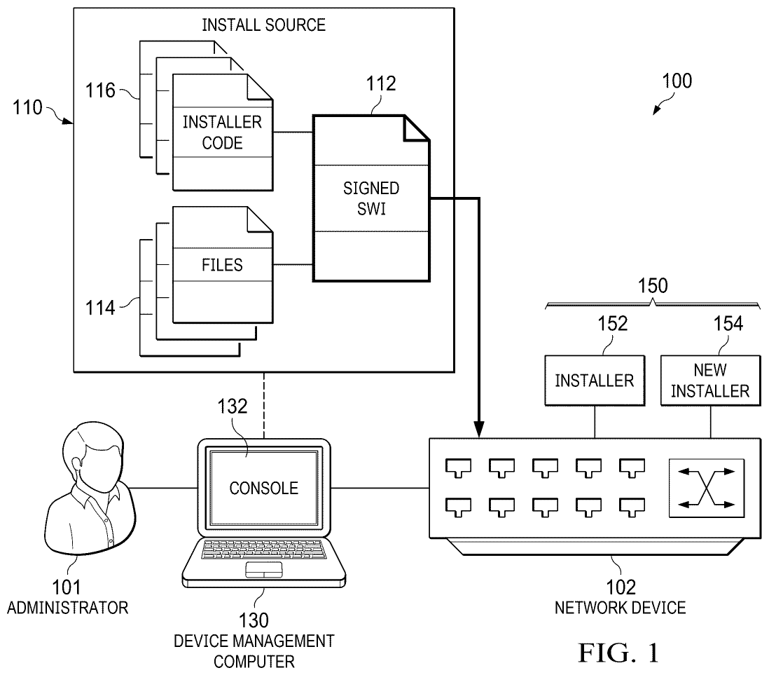

FIG. 1 is a diagrammatic representation of one embodiment of a computer system comprising a target device 102, such as a networked device, a network device, or other computing device, to which software is to be deployed, an install source 110 and a device management computer 130. Install source 110 stores a software image 112 for installing software on target device 102. Install source 110 may be a local install source (e.g., an internal or locally attached drive) or a remote install source accessed over a network. Target device 102 accesses software image 112 from install source 110 and processes software image 112 to install software on target device 102.

Software image 112 is a signed digital container, such as a file, that includes a collection of program files 114 (e.g., code files, configuration data files, etc.) for a piece of software to be installed and signed installer code 116 (e.g., embodied in one or more files). In some instances, program files 114 include files for multiple software programs, such as, but not limited to, different versions of a software program. Similarly, installer code 116 may include installer code for multiple installers. The information in software image 112 may be compressed or encrypted in some embodiments.

An administrator 101 or another user with sufficient privileges accesses a console 132 on device management computer 130 connected to a target device 102 and issues installation commands to direct target device 102 to use software image 112 from install source 110. The installation commands may specify a local install source or a remote install source (e.g., using an FTP path, at a TFTP path, an NFS path, a URL, etc.) and an installation location, such as a directory location in a filesystem of target device 102.

Based on receiving an installation command or in response to another specified event, target device 102 downloads or otherwise accesses software image 112 from install source 110 and processes software image 112 to install the software. Installing the software may include target device 102 executing one or more installers from software image 112 to process software image 112. In some embodiments, target device 102 executes new installers from software image 112 on-the-fly before the entire software image 112 is available to a new installer. For example, target device 102 may execute an installer from software image 112 while still downloading software image 112. Each installer code set in software image 112 may be signed. Thus, target device 102 can verify the signature of a new installer from software image 112 prior to executing the new installer.

To facilitate installation of the software, target device 102 includes an existing installer 152 that is executable to parse software image 112 to extract installer code or program files. For example, existing installer 152 may execute installer code 116 from software image 112 to instantiate new installer 154 to process data from software image 112. New installer 154 may further execute an additional installer from software image 112, and so on.

As will be appreciated, installer 152 may be configured to parse software images that have a known structure of directories and filenames. In some embodiments, software image 112 is only partially compatible with installer 152—that is, software image 112 includes a portion having a structure known to installer 152 and another portion having a structure that is unknown to installer 152. Installer code 116 for new installer 154 is stored in the portion compatible with installer 152. Other portions of software image 112 may have a structure with which installer 152 is not compatible but with which new installer 154 is compatible. Thus, software image 112 may have an overall structure that is different from the structure for which installer 152 is designed but is forward compatible by including code for one or more additional installers that can handle the new structure.

The installer code 116 for new installer 154 is preferably near the start of software image 112 (the start referring to the first part of software image 112 to be downloaded or processed by installer 152). Thus, installer 152 may instantiate new installer 154 while software image 112 is still downloading. Further, installer 152 need only be able to properly read and extract data from the first part of software image 112 because the remainder of software image 112 can be handled by new installer 154.

The instantiation of new installer 154 creates an installer chain 150 in which installer 152 passes data from software image 112 to new installer 154 for processing. As new installer 154 processes the data from software image 112, new installer 154 may execute further new installer code from software image 112 to add another installer to the installer chain 150 and so on.

One or more of the installers in installer chain 150 may act as an adaptation tool that selectively processes or discards files from software image 112 based, for example, on the configuration of the installer or metadata in the software image. Thus, installer chain 150 may selectively keep or discard files from software image 112 to install selected files on target device 102. In some embodiments, each installer in the installer chain 150 passes (e.g., streams) the entire software image 112 to the next installer in chain 150, with the final installer in the chain determining which files to keep or discard. In other embodiments, one or more installers prior to the final installer discards portions of software image 112. For example, installer 152 may discard some files from software image 112 to stream a modified software image to installer 152. Depending on implementation, the modified software image may be the final set of files for installation, or new installer 154 may further discard files from the modified software image to create the final set of files. The final set of files, according to one embodiment, includes a software image file that includes signatures from software image 112 so that the installation can be verified.

In another example embodiment, one or more installers prior to the final installer in the installer chain may install files from software image 112 on target device 102. For example, installer 152 may install some files while new installer 154 installs other files.

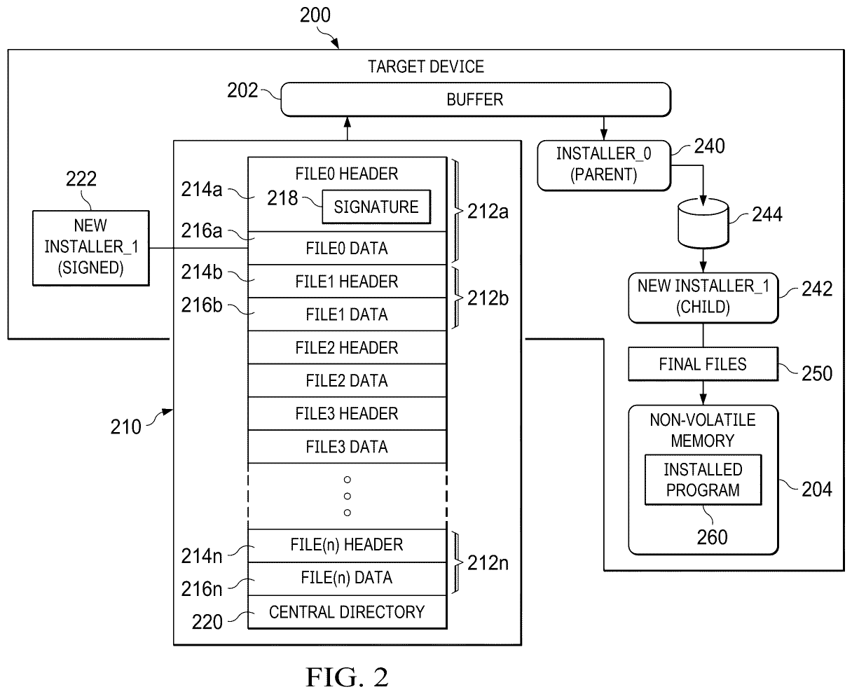

FIG. 2 is a diagrammatic representation illustrating one embodiment of a target device 200 processing software image 210 to install software program 260 on target device 200. Target device 200 may be one example of target device 102. Installing software program 260 includes processing program files from software image 210 to store a final set of files 250 extracted or generated from software image 210 in nonvolatile memory 204. The final set of files 250, according to one embodiment, includes a software image file that includes signatures from software image 210 so that the installation can be verified. Installing software program 260 may include storing the final set of files 250 on target device 200. Installing software program 260 may also include configuring target device 200 by creating directories, updating registries, configuring components to run automatically, setting a boot configuration for target device 200 or otherwise configuring target device 200.

In the example of FIG. 2, software image 210 is a ZIP file. Accordingly, software image 210 includes a series of file entries (e.g., file entry 212a, file entry 212b . . . file entry 212n) followed by a central directory 220. Each file entry includes a local file header (e.g., local file header 214a, local file header 214b . . . local file header 214n) for a corresponding file, followed by the file data (possibly compressed or encrypted) (e.g., file data 216a, file data 216b . . . file data 216n), followed, in some implementations, by a data descriptor. Central directory 220 identifies the files in the file entries and includes pointers to the file entries.

The local file header of a file entry includes metadata about the corresponding file in the file entry, such as the filename, file size, compression technique, etc. For example, local file header 214a holds metadata about “File0”. In some embodiments, the metadata for the file includes a signature for the file (e.g., as a record in the extra field of the local file header). Local file header 214a may include, for example, a digital signature 218 for “File0”, such as a hash of file data 214b. This signature can be used by target device 200 to verify File0 before further processing of File0.

As will be appreciated, the file entries of a ZIP file can include a variety of different file types, including additional ZIP files. In the embodiment illustrated, file data 216a—that is, File0—includes new installer code 222 packaged as a compressed executable file. As discussed below, target device 200 may execute installer code 222 on-the-fly from software image 210.

Central directory 220 includes a copy of the information in the local file headers and additional information about the files, particularly the location (offset) of each file entry in software image 210. In some embodiments, central directory 220 may also include a unique signature for software image 210.

Target device 200 includes an existing installer 240 that is configured to parse software images having a known structure to extract and process files having predefined characteristics. Processing a file may include, in one embodiment, one or more of verifying a signature of the file, executing the file or copying the file to nonvolatile memory 204. As an example, existing installer 240 may be configured to read local file headers from software image 210, extract a file named “File_0,” verify file's signature, and if the signature is valid, execute File_0.

In operation, target device 200 receives software image 210 as a data stream and buffers the streaming data in buffer 202 (e.g., in volatile memory). If not already executing, target device 200 executes installer 240 and installer 240 begins installation processing of software image 210 from buffer 202. Here, installer 240 reads local file header 214a and identifies that File0 to execute based on the filename contained in local file header 214a. Installer 240 extracts File0 from file data 216a and attempts to verify File0 using signature 218. If signature 218 cannot be verified, installer 240 may terminate the installation process and generate an error. If signature 218 is valid, installer 240 executes new installer code 222 to instantiate new installer 242. In one embodiment, installer 240 forks to create a child process, executes new installer 242 in the child process, and streams data from software image 210 to new installer via a pipe 244. Thus, installer 240 and installer 242 run as different processes.

One or more of the installers in the installer chain may act as an adaptation tool that selectively processes and discards files from software image 210 based, for example, on the configuration of the installer or metadata in the software image. Thus, the installer chain may selectively process or discard files from software image 210 to install a final set of files 250 extracted or generated from software image 210. The final installer in the chain (e.g., installer 242) may begin storing the final set of files 250 as the data becomes available—for example, installer 242 may begin streaming or writing the files that constitute final set of files 250 before it has received all of a modified software image or full software image 210 from installer 240 and, in some cases, even before software image 210 finishes downloading.

In some embodiments, each installer in the installer chain passes (e.g., streams) the entire software image 210 to the next installer in the chain, with the final installer in the chain determining which files to keep or discard. In such an embodiment, installer 240 streams all of software image 210 to installer 242 and installer 242 is responsible for selecting which files from software image 210 to process or discard to create final set of files 250. In other embodiments, one or more installers prior to the final installer discards portions of software image 210. For example, installer 240 may discard some files from software image 210 to stream a modified software image to installer 242. Depending on implementation, the modified software image may be a final software image, or installer 242 may further discard files from the modified software image to create final set of files 250.

In another example embodiment, one or more installers prior to the final installer in the installer chain may install files from software image 210 on target device 200. For example, installer 240 may install some files while installer 242 installs other files.

In the embodiment of FIG. 2, new installer code 222 is located near the start of software image 210. Thus, installer 240 may instantiate installer 242 while software image 210 is still downloading. Further, installer 240 needs only be able to properly read and extract data from the first part of software image 210 because installer 240 can pass incompatible portions of software image 210 to installer 242 for processing.

In conventional processing of ZIP files, only the files specified in the central directory are considered valid. By signing new installer code 222 individually and including the signature in file entry 212a, installer 240 can verify that installer code 222 is valid without having to wait for central directory 220 to download. Further, signing installer code 222 individually allows target device 200 to maintain a security model of not executing unverified code, but without having to wait for the entire software image 210 to be downloaded for verification. Thus, some embodiments can maintain security while supporting streaming.

In the foregoing example, existing installer 240 is configured to scan the software image for File0 and execute the file. In some embodiments, installer configuration data (e.g., criteria for selecting or discarding files from software image 210) may be included in the installation commands issued to the target device. In addition, or in the alternative, the software image may include installer configuration data. In other embodiments, one or more installers may be hardcoded to select or discard files from software image 210.

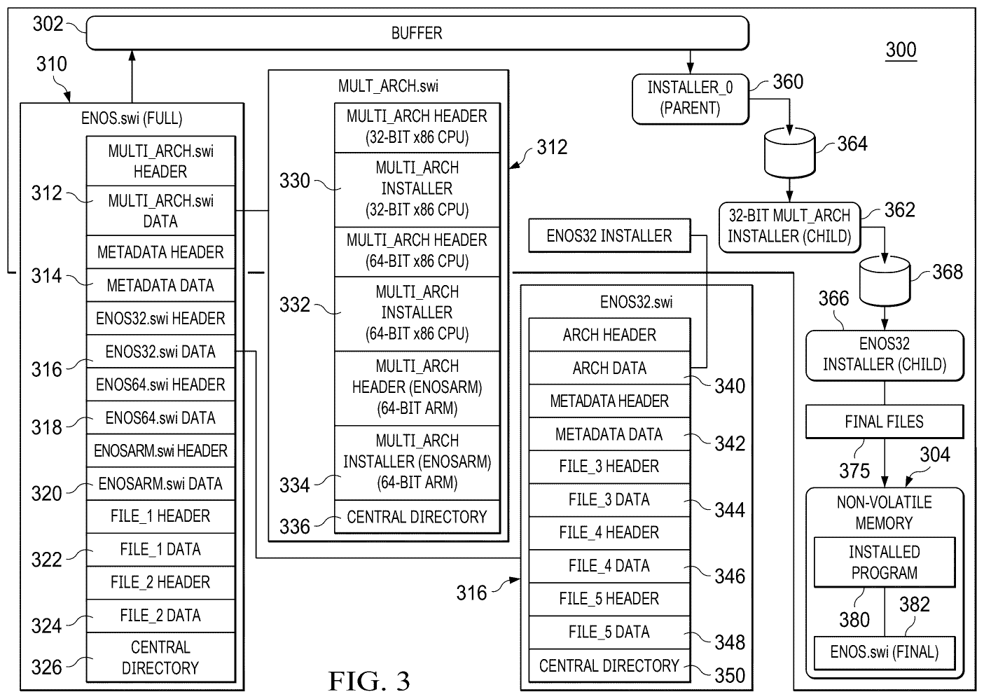

The techniques described herein provide a flexible software image structure that can include multiple installable software programs and respective installer code sets. The flexible software image can be used to provide, for example, forward compatible, secure streaming, recursive, multi-architecture software images. FIG. 3, for example, is a diagrammatic representation of one embodiment of installing or extending an extendable network operating system (ENOS) using a forward compatible, secure streaming, recursive, multi-architecture full ENOS.swi software image file 310 to install software 380 on target device 300. As discussed below, installing software 380 may include installing a final ENOS.swi software image file 382 at a boot location on target device 300.

Installing software 380 includes extracting and processing program files from software image file 310 to create a final set of files 375 extracted or generated from software image file 310. In one embodiment, final set of files 375 includes a final ENOS.swi file that is created by removing files from ENOS.swi software image file 310. Installing software 380 may include storing the files of final set of files 375 to appropriate locations on target device 300, such as, but not limited to, installing final ENOS.swi at a boot location. Installing software 380 may also include configuring target device 300 by creating directories, updating registries, configuring components to run automatically, setting a boot configuration for target device 300 or otherwise configuring target device 300.

ENOS is a fully programmable, highly modular, scalable Linux-based extensible network operating system (ENOS) for network devices such as switches, routers, access points, gateways, firewalls, etc. The ENOS is built on top of a Linux kernel that natively supports compiled applications packaged as Red Hat package manager files (RPMs). RPMs are known to those skilled in the art and thus are not further described herein. The software program files included in full ENOS.swi software image file 310 may thus include RPMs to update or extend an ENOS.

ENOS.swi software image file 310 can contain proprietary software packages as well as third party software packages, allowing a variety of software applications be installed and run on ENOS-enabled network devices to deliver workflow automation, high availability, network visibility and analytics, and rapid integration with a wide range of third-party applications for virtualization, management, automation and orchestration services.

ENOS-enabled network devices are often installed by administrators, site managers, or other authorized users at remote sites (e.g., a customer-defined location or a branch office). As a non-limiting example, an administrator may enter an interactive command-line interface (CLI), such as the Aboot shell, to manually boot an ENOS-enabled switch. The ENOS-enabled switch has an internal nonvolatile memory (e.g., flash storage or another nonvolatile memory) which contains an ENOS software image load file named “ENOS.swi” at a specified location from which the switch is booted. The administrator may manually enter installation commands or view/modify installation commands contained in a boot configuration file (e.g., a boot-config file) that is used during switch booting.

The installation commands can include a command that specifies the location and filename of the ENOS software image load file used for booting the switch. The ENOS software image load file may reside locally on the switch's internal flash drive (e.g., SWI=flash: ENOS.swi) or at a network address (e.g., SWI=http://foo.com/images/ENOS.swi). Other locations may also be possible (e.g., in the switch directory, on a USB drive, at an FTP path, at a TFTP path, at an NFS path, etc.). Installing software 380 may thus include storing a final ENOS.swi software image file 382 at the specified boot location.

Embodiments of the present disclosure may use copies of the same software image to install software on devices having different architectures. To this end, multi-architecture ENOS.swi software image file 310 includes versions of an updated ENOS or ENOS extensions for a 32-bit x86 architecture (e.g., devices with a 32-bit x86 CPU), a 64-bit x86 architecture, and an 64-bit ARM architecture. ENOS.swi software image file 310 also includes installer code for the different architectures. Thus, copies of the same software image may be used to deploy software to devices having various architectures.

In the illustrated embodiment, ENOS.swi software image file 310 is a file according to the ZIP file format that includes file entries and a central directory 326, which may include a signature for ENOS.swi software image file 310. Each file entry includes a local file header and corresponding file (e.g., Multi_Arch.swi file 312, a Metadata file 314, ENOS32.swi file 316, ENOS64.swi file 318, ENOSARM.swi file 320, program file 322 (File_1), program file 324 (File_2)).

Multi_Arch.swi file 312 is a software image file according to a ZIP file format and thus includes file entries and a central directory 336. The file entries include a local file header and corresponding file. In this example, the files include Multi_Arch Installer (32-bit x86) code 330, Multi_Arch Installer (64-bit x86) code 332, Multi_Arch Installer (64-bit ARM) code 334, and central directory 336. Each of Multi_Arch Installer (32-bit x86) code 330, Multi_Arch Installer (64-bit x86) code 332, Multi_Arch Installer (64-bit ARM) code 334 is signed in its respective local file header. Central directory 336 may include a signature for Multi_Arch.swi file 312.

Each of the Multi_Arch installers is designed to run on a particular architecture (32-bit x86, 64-bit x86, or 64-bit ARM). Further, each of the Mulit_Arch installers is configured to read the file entries of ENOS.swi software image file 310 to identify files for processing. In one embodiment, for example, each of the Multi_Arch installers is configured to identify a file named ENOS/Metadata file—that is Metadata file 314—in ENOS.swi software image file 310 and access additional configuration data from the metadata file.

Metadata file 314 includes configuration information for the Multi_Arch installers. Metadata file 314 for example may include installer configuration information such as:
Multi_Arch Installer (32-bit x86)→“NOS/ENOS32/Arch”
Multi_Arch Installer (64-bit x86)→“NOS/ENOS64/Arch”
Multi_Arch Installer (64-bit ARM)→“NOS/ENOSARM/Arch”

In this example, metadata file 314 specifies files for the Multi_Arch installers to process.

ENOS32.swi 316 is also a software image file according to a ZIP file format and includes local file headers, corresponding files, and a central directory 350. The files include an Arch file 340 that includes installer code for an ENOS32 installer, metadata file 342, program file 344 (File_3), program file 346 (File_2), program file 348 (File_3). The ENOS32 installer is configured to extract configuration information from ENOS/ENOS32/Metadata—that is, metadata file 342. Metadata file 342 includes installer configuration data for the ENOS32 installer. For example, metadata file 342 may specify that the ENOS32 installer is to extract ENOS/File_1, ENOS/ENOS32/File_3, ENOS/ENOS32/File_4, ENOS/ENOS32/File_5. The ENOS32 installer code may be signed in the local file header. Central directory 336 may contain a signature for ENOS32.swi.

Target device 300 includes an existing installer 360 that is executable to parse software images having a known structure to extract and process files having predefined characteristics. Processing a file may include, for example, one or more of verifying a signature of the file, executing the file or copying the file to nonvolatile memory 304. More particularly, installer 360 is executable to identify and process the file ENOS/Multi_Arch—that is, Multi_Arch.swi file 312—and identify and extract the installer code corresponding to the CPU architecture of device 300 from Multi_Arch.swi file 312. For the sake of example, a 32-bit x86 architecture is used.

In operation, target device 300 receives ENOS.swi software image file 310 as a data stream and buffers the streaming data in buffer 302 (e.g., in volatile memory). If not already executing, target device 300 executes installer 360 and installer 360 begins installation processing of ENOS.swi software image file 310 from buffer 302. Here, installer 360 reads the Multi_Arch.swi header and identifies that the corresponding file ENOS/Multi_Arch.swi file 312 is a file to extract and process (e.g., based on the filename in the local file header for Multi_Arch.swi file 312). Installer 360 reads data from buffer 302 and parses the local file headers of Multi_Arch.swi file 312 and identifies Multi_Arch Installer (32-bit x86) code 330 as a file to execute (e.g., based on the filename or other file metadata in the local file header). Installer 360 attempts to verify the file signature of Multi_Arch Installer (32-bit x86) code 330. If the signature cannot be verified, installer 360 may terminate the installation process and generate an error.

If the signature is valid, installer 360 executes Multi_Arch Installer (32-bit x86) code 330 to instantiate 32-bit Multi_Arch Installer 362. In one embodiment, installer 360 forks to create a child process, executes 32-bit Multi_Arch Installer 362 in the child process, and streams data from ENOS.swi software image file 310 to 32-bit x86 Multi_Arch Installer 362 via pipe 364. Thus, installer 360 and 32-bit x86 Multi_Arch Installer 362 run as different processes.

32-bit Multi_Arch Installer 362 is executable to identify the file ENOS/Metadata (metadata file 314) from ENOS.swi software image file 310 and extract additional configuration data from the file. Thus, as data is streamed to 32-bit x86 Multi_Arch Installer 362, 32-bit x86 Multi_Arch Installer 362 parses the local file headers and identifies that metadata file 314 as a file from which to extract configuration information (e.g., based on the filename in the local file header for metadata file 314). Accordingly, 32-bit x86 Multi_Arch Installer 362 parses metadata file 314 to determine that it is to process the file “ENOS/ENOS32/Arch.”

As 32-bit x86 Multi_Arch Installer 362 continues to process data streamed from installer 360, 32-bit x86 Multi_Arch Installer 362 identifies the ENOS32.swi file 316 as a file to extract and process. For example, Multi_Arch Installer 362 identifies ENOS32.swi file 316 based on the filename in the corresponding local file header matching the name in the path ENOS/ENOS32/Arch specified by the installer configuration information extracted from metadata file 314.

Accordingly, 32-bit x86 Multi_Arch Installer 362 extracts and processes ENOS32.swi file 316. More particularly, 32-bit x86 Multi_Arch Installer 362 parses the local file headers from ENOS.swi file 316 as they are received and identifies Arch file 340 as a file to extract and execute. For example, Multi_Arch Installer 362 identifies Arch file 340 based on the filename in the corresponding local file header matching the filename in the path ENOS/ENOS32/Arch specified by the installer configuration information extracted from metadata file 314. 32-bit x86 Multi_Arch Installer 362 attempts to verify the file signature of Arch file 340. If the signature cannot be verified, Multi_Arch Installer 362 may terminate the installation process and generate an error.

If the signature is valid, 32-bit x86 Multi_Arch Installer 362 executes the ENOS32 installer code to instantiate ENOS32 Installer 366. In one embodiment, 32-bit x86 Multi_Arch Installer 362 to create a child process, executes ENOS32 Installer 366 in the child process, and streams data from ENOS.swi software image file 310 to ENOS32 Installer 366 via pipe 368.

ENOS32 Installer 366 is executable to locate and extract installer configuration information from the file ENOS/ENOS32/Metadata—that is, metadata file 342. Thus, as ENOS.swi software image file 310 is streamed to ENOS32 Installer 366, ENOS32 Installer 366 identifies the ENOS32.swi file 316 as a file to extract and process. For example, ENOS32 Installer 366 identifies ENOS32.swi file 316 based on the filename in the corresponding local file header matching the name in the path ENOS/ENOS32/Metadata.

Accordingly, ENOS32 Installer 366 extracts and processes 32-bit ENOS32.swi file 316. More particularly, 32-bit x86 Multi_Arch Installer 362 parses the local file headers from ENOS32.swi file 316 as they are received and identifies metadata file 342 as a file to extract and execute. For example, ENOS32 Installer 366 identifies metadata file 342 based on the filename in the corresponding local file header matching the filename in the path ENOS/ENOS32/Metadata. ENOS32 Installer 366 therefore parses metadata file 344 to determine that it is to process the program files ENOS/File_1, ENOS/ENOS32/File_3, ENOS/ENOS32/File_4, ENOS/ENOS32/File_5.

As ENOS32 Installer 366 continues to process data of ENOS32.swi file 316 streamed from 32-bit x86 Multi_Arch Installer 362, ENOS32 installer 366 identifies program file 344 (File3), program file 346 (File4), program file 348 (File5) as files to extract and process. For example, ENOS32 Installer 366 identifies these files as matching the filenames of program files specified by metadata file 342 for processing. Similarly, as ENOS32 Installer 366 continues to process other data from ENOS.swi software image file 310, ENOS32 installer 366 identifies program file 322 (File_1) as a file to process. ENOS32 Installer 366 discards other files from ENOS.swi software image file 310 to stream final set of files 375 to non-volatile memory.

In the embodiment of FIG. 3, installer 360 and 32-bit x86 Multi_Arch Installer 362 pass the entire ENOS.swi software image file 310 to the next installer in the chain. ENOS32 Installer 366 acts as a software adaptation tool to selectively process or discard files from ENOS.swi software image file 310 to create final set of files 375. In other embodiments, one or more installers prior to the final installer discards portions of ENOS.swi software image file 310. For example, installer 360 may discard some files from ENOS.swi software image file 310 to stream a modified software image to 32-bit x86 Multi_Arch Installer 362 and 32-bit x86 Multi_Arch Installer 362 may discard some files to stream a still further modified software image to ENOS32 Installer 366. Depending on implementation, the modified software image may be a final software image, or ENOS32 Installer 366 may further discard files from the modified software image to create the final software image.

In one embodiment, the program files (e.g., program file 322 (File_1), program file 324 (File_2), program file 344 (File_3), program file 346 (File_4), program file 348 (File_5)) are ENOS extensions packaged as compressed read-only file system files (e.g., ENOS.swix files). In some embodiments, these compressed read-only filesystem files are unpacked, extracted, and parsed on the fly while the full ENOS.swi is being downloaded from an install source. As an individual software package is read from ENOS.swi software image file 310 or a contained software image (e.g., ENOS32.swi file 316), the installer chain can use a filename and other metadata contained in the header information to determine whether to keep the individual software package based on configuration settings (e.g., user specified configuration settings, or as provided by the administrator in the installation commands), configuration settings in metadata file 314, configuration settings in metadata file 342). For instance, suppose the individual software package comprises a SWIX file and metadata file 342 includes a SWIX filename. The installer chain can determine whether to process the SWIX file based on whether the SWIX file has a filename that matches the SWIX filename specified in the configuration setting.

If the SWIX file read from ENOS.swi software image file 310 is to be processed, the installer chain extracts an ENOS extension and a corresponding signature from the SWIX file and stores the ENOS extension with the corresponding signature on the nonvolatile memory 304. The installer chain may further remove the file and corresponding local file header from ENOS.swi (or contained software image file). If a file is not to be processed, the installer chain can remove the file and corresponding local file header from ENOS.swi without storing the extension to nonvolatile memory 304.

The on-the-fly modification of the software image can result in a final ENOS.swi software image file 382 that still has a signature like the full ENOS.swi software image file 310, but that does not contain the ENOS extension software packages as all the software packages have been read/removed. The nonvolatile memory 304 does not necessarily store all the software packages read/removed from the software image, unless they all have been indicated (e.g., per configuration settings) as being wanted. Rather, nonvolatile memory 304 may store a subset of the ENOS extensions with corresponding signatures extracted from the software packages.

Thus, according to one embodiment, final ENOS.swi software image file 382 stored on the nonvolatile memory 304 does not contain any ENOS extensions. However, it still contains a valid signature. All the ENOS extensions that have been extracted on the fly and stored on nonvolatile memory 304 will also have valid signatures. That is, the final ENOS.swi software image file 382, even if it no longer contains any ENOS extensions, will have a matching valid signature which can be verified after having the ENOS extensions stripped from it. Further, any ENOS extensions thus extracted and stored will also have their own signatures which can be verified.

According to one embodiment, each compressed read-only filesystem file, which corresponds to a software package selected for installation, is mounted in an overlay filesystem (e.g., OverlayFS) as read-only, allowing the software package to only be loaded into memory (e.g., RAM) as used or needed. OverlayFS is known to those skilled in the art and thus is not further described herein. The ENOS extensions thus obtained from the full ENOS.swi software image file 310 could take on different formats which, in turn, would be installed or loaded differently, depending on the internal file contents of a respective ENOS extension.

In some embodiments, after download is complete, the subset of the ENOS extensions stored on nonvolatile memory 304 can be verified using the corresponding signatures so as to determine valid ENOS extensions for inclusion in an overlay filesystem which becomes a root filesystem for the network device. The signature of final ENOS.swi software image file 382 is also verified before booting the network device into the modified software image. Such signature verifications can be performed, for example, by a boot loader on the network device before booting the network device into the modified SWI. Signature verification is known to those skilled in the art and thus is not further described herein.

The location in the installer chain where the decision is made to process or discard a particular file may occur at any point in the installer chain. In one embodiment, for example, installer 360 and 32-bit x86 Multi_Arch Installer 344 pass the entire ENOS.swi software image file 310 to the next installer in the chain. ENOS32 Installer 366 selects the files from ENOS.swi software image file 310 to store to nonvolatile storage. In one embodiment, ENOS32 Installer 366 stores final ENOS.swi 382 to the boot location specified in the installation commands.

In the example of FIG. 3, software image file 310 includes installers for various CPU architectures and the installer chain on target device 300 installs final files 375 suitable for the architecture of the target device while discarding files that are not used on target device 300 (e.g., discards files for other CPU architectures). However, this is just one example.

Software image files according to the present disclosure may include program files for applications corresponding to any number of target device characteristics and installers for installing the applications. According to some embodiments, one or more installers can be selectively executed from the software image based on configuration data from the software image file, configuration data on the target device, or other configuration data or through hard coding of an installer on the target device. Further, an installer may selectively process or discard files based on configuration data from the software image file, configuration data on the target device, or other configuration data or through hard coding. Thus, for example, an installer executed from the software image file may use configuration data to select which files to process from the software image file to process and which files to discard.

As just one example, a software image file may include program files for various versions of an application to be installed, where the program files include i) files for target devices that do not use virtual machines or Docker containers; ii) files for a virtual machine installation; iii) files for a Docker container installation. The software image may further include one or more installers. In this example, an installer selected for execution on a target device that does not use virtual machines or Docker containers can be configured to process the files for target devices that do not use virtual machines or Docker containers and discard the files for the virtual machine installation and the files for the Docker container installation. Similarly, an installer selected for execution on a virtual machine may be configured to process the files for the virtual machine installation and discard the files for target devices that do not use virtual machines or Docker containers and the files for a Docker container installation. Further, an installer selected for execution on a target device that uses Docker containers may be configured to process the files for a Docker container installation and discard the files for target devices that do not use virtual machines or Docker containers and the files for a virtual machine installation. As discussed, such configuration, in some embodiments, can be implemented through configuration data, such as configuration data on the target device (e.g., configuration data provided with the installation commands) or configuration data included in the software image file.

Embodiments of the present disclosure provide a highly flexible mechanism for installing software from a software image file. The software image file can include program files for any number of applications tailored to any number of target device hardware or software characteristics (e.g., CPU architecture, memory, GPU, whether the target device uses Docker containers, software already installed on the target device). One or more installers can be configured to selectively process and install program files and discard program files based, for example, on configuration data on the target device or included in the software image that specifies criteria for selecting files for installation. Thus, a software image file that includes multiple applications—including, but not limited, multiple versions of an application, where each version may correspond to a different set of target device characteristics—can be used to install the appropriate software on a given target device without, in some embodiments, installing the application files that are not used on that target device.

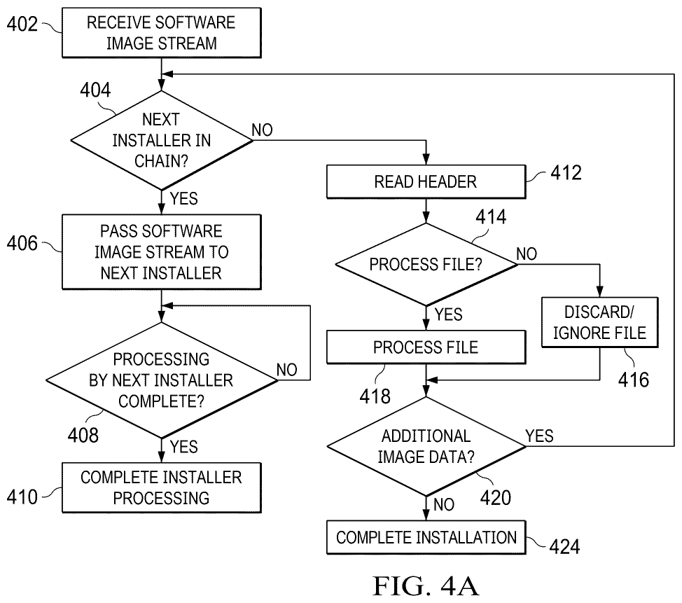

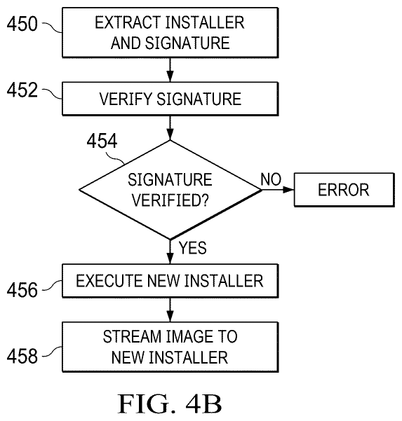

FIG. 4A is a flow chart that illustrates an example of a process for installing software by a current installer, which may be an existing installer (e.g., installer 150, installer 240, installer 360) or a new installer (e.g., installer 152, installer 242, 32-bit x86 Multi-Arch Installer 362, ENOS32 Installer 366). In one embodiment a target device (e.g., target device 102, target device 200, target device 300) receives a command or instruction from a device management computer to download a software image from an install source and, accordingly, begins downloading the software image.

At step 402, an installer executing on the target device receives a streamed software image. For example, an existing installer may read data of the software image being from a buffer or a new installer executed from the software image may receive the software image stream from a prior installer in an installer chain.

If there is already a next installer executing in the installer chain (step 404), the current installer, at step 406, streams the software image to the next installer. For example, installer 150 streams software image 112 to installer 152, installer 240 streams software image 210 to installer 242, installer 360 streams ENOS.swi software image file 310 to 32-bit x86 Multi-Arch Installer 366, 32-bit x86 Multi-Arch Installer 362 streams ENOS.swi software image file 310 to ENOS32 Installer 366.

The current installer continues to stream the software image to the next installer in the installer chain until all the software image data has been streamed. At step 408, the current installer waits to receive a completion message from the next installer. When the current installer receives an indication that the next installer has completed its processing of the software image, the current installer completes its installation processing (step 410). For example, the installer may send an indication that installation processing is complete to a previous installer in the installer chain and stop execution.

If there is not a next installer in the installer chain (e.g., the current installer is the last installer in the installer chain), the current installer, at step 412, extracts and reads the local file header as they become available and determines, at step 414, whether to process the corresponding file. For example, the current installer may identify the file as a file to be processed based on file metadata in the header matching selection criteria specified in configuration settings for the installer. In some embodiments, the configuration settings for an installer are specified in one or more of the configuration data included in the installation commands issued to the target device or configuration data included in the software image. For example, the configuration data may specify that an installer is only to install files having certain filenames, where the filenames specified match the filenames of files for installing the application on the target device given the target device's characteristics. Continuing with this example, the configuration data for a target device with a 32-bit CPU architecture and that supports Docker containers may thus specify different file names than the configuration data for a target device with a 32-bit CPU architecture but that does not use Docker containers.

If the file is not identified as a file to be processed by the current installer, the installer, at step 416 may ignore or discard the file, depending on implementation. For example, in one embodiment, installers in the installer chain prior to the final installer ignore files at step 416, but do not discard them from the software image, whereas the final installer in the installer chain discards the file. If the file is identified as a file to be processed by the current installer, the installer, at step 418 processes the file. Processing the file may include, for example, extracting the file and signature and storing the file and signature to non-volatile memory of the target device, extracting configuration settings from the file, or executing the file. As indicated at step 420, the current installer can continue processing the streamed image until, for example, the entire software image data has been considered. At step 424, the current installer completes installation processing of the software.

FIG. 4A is merely provided as an illustrative example. Embodiments may, for example, perform the steps in different orders, omit steps, repeat steps, or perform alternative steps.

The processing of a file at step 418 can take various forms depending on the type of file. FIG. 4B is a flow chart illustrating one embodiment of a method for processing a file containing new installer code. At step 450, the current installer extracts the new installer code and file signature for the new installer code from the software image. At step 452, the current installer attempts to verify the signature. If the signature cannot be verified (step 454), the installer generates an error (step 456), and the installation process ends.

If the signature is verified (step 454), the current installer, at step 456, executes the new installer as the next installer in the installer chain. According to one embodiment, the current installer forks to create a child process and executes the new installer in place in the child process. The current installer begins streaming the software image to the new installer at step 458. As discussed with respect to FIG. 4A, the current installer can continue streaming the software image to the new installer until all the software image data has been streamed. Further, the current installer may wait to receive a completion message from the new installer before terminating its own processing.

FIG. 4B is merely provided as an illustrative example. Embodiments may, for example, perform the steps in different orders, omit steps, repeat steps or perform alternative steps.

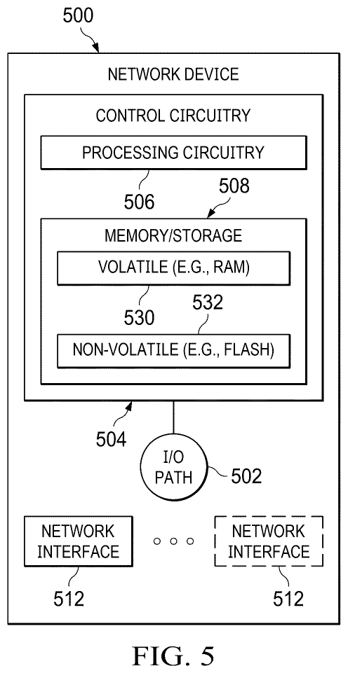

FIG. 5 depicts a diagrammatic representation of an example architecture of a target device 500, such as a network device, according to some embodiments disclosed herein. Target device 500 may receive data via an input/output (I/O) path 502. I/O path 502 provides packet data to a control circuitry 504, which includes a processing circuitry 506 and a storage 508 (i.e., memory). Control circuitry 504 may send and receive commands, requests, and other suitable data using the I/O path 502. In turn, I/O path 502 connects the control circuitry 504 (and specifically processing circuitry 506) to one or more network interfaces 512, to which other devices can be connected. These network interfaces may be any type of network interface, such as an RJ45 ethernet port, a coaxial port, etc.

Control circuitry 504 includes processing circuitry 506 and storage 508. As referred to herein, the term “processing circuitry” should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, octa-core, or any suitable number of cores). Processing circuitry 506 can be distributed across multiple separate processors or processing units, for example, multiple of the same type of processing units (e.g., two INTEL CORE i7 processors) or multiple different processors (e.g., an INTEL CORE i5 processor and an INTEL CORE i7 processor). The circuitry described herein may execute instructions included in software running on one or more general purpose or specialized processors.

Storage 508 comprises an electronic storage device. As referred to herein, the phrase “electronic storage device” or “storage device” should be understood to mean any device for storing electronic data, computer software, instructions, or firmware, such as RAM, content-addressable memory (CAM) (including a TCAM), hard drives, optical drives, solid state devices, quantum storage devices, or any other suitable fixed or removable storage devices, or any combination of the same. Other implementations may also be possible. In particular, storage 508 includes a volatile RAM 530, which does not retain its contents when power is turned off, and a nonvolatile RAM 532, which does retain its contents when power is turned off.

In some embodiments, storage 508 includes installer code (e.g., embodied on a non-transitory computer-readable medium) that is executable by processing circuitry 506 to implement one or more installers.

In this disclosure, specific embodiments have been described with reference to the accompanying figures. In the above description, numerous details are set forth as examples. It will be understood by those skilled in the art, and having the benefit of this Detailed Description, that one or more embodiments described herein may be practiced without these specific details and that numerous variations or modifications may be possible without departing from the scope of the embodiments. Certain details known to those of ordinary skill in the art may be omitted to avoid obscuring the description.

In the above description of the figures, any component described with regard to a figure, in various embodiments, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for installation of software, the method comprising:
downloading, at a target device, a software image over a network from an install source, the target device comprising first installer code, and the software image comprising second installer code and software program files for a software program to be installed;
installing the software program on the target device from the software image, wherein installing the software program on the target device comprises:
extracting, by the first installer code, the second installer code from the software image while the software image is downloading from the install source;
executing, by the first installer code, the second installer code; and
processing the software image using the second installer code.

2. The method of claim 1, wherein the target device comprises a buffer, wherein the target device receives the software image as a stream, and wherein the method further comprises:
buffering first streaming data in the buffer as buffered data, the first streaming data representing a first portion of the software image;
passing, by the first installer code, the buffered data to the second installer code; and
passing, by the first installer code, a second portion of the software image to the second installer code.

3. The method of claim 1, wherein the software image comprises a signature of the second installer code and wherein the method further comprises:
validating the signature of the second installer code prior to executing the second installer code at the target device.

4. The method of claim 1, wherein the second installer code is extracted and executed prior to the target device receiving the entire software image.

5. The method of claim 1, wherein the software image comprises third installer code, metadata for the second installer code, and metadata for the third installer code, and wherein the method comprises:
selecting, by the first installer code, the second installer code for extraction and execution, wherein the first installer code selects the second installer code using the metadata for the second installer code.

6. The method of claim 5, wherein the second installer code is associated with a first device architecture and the third installer code is associated with a second device architecture.

7. The method of claim 5, wherein installing the software program on the target device from the software image further comprises:
selecting, by the second installer code, the third installer code for extraction, wherein the second installer code selects the third installer code for extraction using the metadata of the third installer code;
extracting, by the second installer code, the third installer code from the software image;
executing, by the second installer code, the third installer code; and
processing the software image using the third installer code.

8. The method of claim 1, further comprising selectively processing or discarding the software program files by the second installer code.

9. The method of claim 1, the software image is a compressed file comprising:
a first portion compatible with the first installer code, the first portion including the second installer code;
a second portion compatible with the second installer code, the second portion including a first of the software program files of the software program to be installed; and
a third portion comprising a second of the software program files of the software program to be installed, wherein the second installer code is executable to install the first of the software program files and discard the second of the software program files.

10. The method of claim 1, wherein the software image is an operating system (OS) image file comprising a multi-architecture OS image.

11. A network device comprising:
a processor;
a nonvolatile memory; and
instructions stored on the nonvolatile memory and translatable by the processor for:
downloading a software image over a network from an install source;
while the software image is downloading:
identifying new installer code for execution from the software image;
extracting and executing the new installer code from the software image to instantiate a new installer; and
streaming software image data to the new installer for processing.

12. The network device of claim 11, wherein the instructions are further translatable by the processor for:
buffering first streaming data in the buffer as buffered data, the first streaming data representing a first portion of the software image;
passing the buffered data to the new installer; and
passing a second portion of the software image to the new installer.

13. The network device of claim 11, wherein the software image comprises a signature of the new installer code and wherein the instructions are further translatable by the processor for:
validating the signature of the new installer code prior to executing the new installer code at the network device.

14. The network device of claim 11, wherein the instructions are further translatable by the processor for:
reading metadata for the new installer code from the software image; and
selecting the new installer code for extraction and execution using the metadata for the new installer code.

15. The network device of claim 11, wherein the new installer code is associated with a processor architecture of the network device.

16. The network device of claim 15, wherein the instructions are further translatable by the processor for ignoring or discarding installer code associated with a different processor architecture.

17. The network device of claim 15, wherein the software image is partially compatible with the instructions on the network device.

18. The network device of claim 15, wherein the software image is an operating system (OS) image file comprising a multi-architecture OS image.

19. A computer program product comprising a non-transitory, computer-readable medium storing instructions translatable by a processor for:
downloading a software image over a network from an install source;
while the software image is downloading:
identifying new installer code for execution from the software image;
extracting and executing the new installer code from the software image to instantiate a new installer; and
streaming software image data to the new installer for processing.

20. The computer program product of claim 19, wherein the instructions are further translatable by the processor for:
buffering first streaming data in the buffer as buffered data, the first streaming data representing a first portion of the software image;
passing the buffered data to the new installer; and
passing a second portion of the software image to the new installer.
